(19) United States
(12) Patent Application Publication
(10) Pub. No.: US 2012/0263838 A1
(43) Pub. Date: Oct. 18, 2012

(54) METHOD FOR RENDERING ANIMAL MATERIALS

(75) Inventor: John D. Johnston, Jeffersonville, IN (US)

(73) Assignee: GEO. PFAU'S SONS COMPANY, INC., Jeffersonville, IN (US)

(21) Appl. No.: 13/445,382

(22) Filed: Apr. 12, 2012

Related U.S. Application Data
(60) Provisional application No. 61/474,602, filed on Apr. 12, 2011.

(51) Int. Cl. A23B 4/20

(52) U.S. Cl. 426/271

(57) ABSTRACT

A method for rendering animal materials is provided that includes the steps of providing one or more animal materials, and applying an amount of a chelating solution to the animal materials prior to heating the materials in a cooker. The method further includes the step of heating the materials to thereby release at least some water and fat from the material, and then pressing the materials to further release water and fat from the materials. An antioxidant composition is further applied to the materials to provide rendered animal materials having an increased quality and long-term stability.

### RELATED APPLICATIONS

This application claims priority from U.S. Provisional Application Ser. No. 61/474,602, filed Apr. 12, 2011, the entire disclosure of which is incorporated herein by this reference.

### TECHNICAL FIELD

The present invention relates to methods for rendering animal materials. In particular, the present invention relates to methods for rendering animal materials, such as poultry, fish, pork, beef, or lamb materials, wherein a chelating solution is applied to the materials at the outset of a rendering process.

### BACKGROUND

In a rendering process, poultry, fish, pork, beef, lamb, or other animal materials are generally heated in a controlled atmosphere cooker such that the water and water-based substances in the materials begin to evaporate, the materials themselves break down, and the fats and lipids in the materials separate from the protein and other components of the materials. Then, after leaving the cooker, the materials are decanted and/or pressed to squeeze the remaining water and fat from the solid materials (i.e., the protein meals). Finally, “post-press,” the solid materials may be passed through a hammer mill or similar machine to break or crush the material into a dry meal or coarse powder, and the materials may be further dried as necessary. During the process, an antioxidant composition is also typically added to the materials, either while the materials are in the cooker or anytime thereafter.

Despite the application of the antioxidant compositions, however, a common problem with such rendering processes is rancidity, where the chemical decomposition of the materials leads to undesirable odors and flavors and/or renders the materials unsafe for consumption. It is recognized that rancidity following the rendering of poultry, or other animal by-products such as fish, results from the heat, oxygen and the catalytic effect of non-chelated metals, including, for example, iron, copper, and nickel, which are all present during the rendering process. For example, the problem of rancidity is particularly profound in the manufacturing of chicken meal and the resulting fat from that process, due to the typically higher levels of iron found in the parts of the chicken that are selected to make chicken meal, such as for the pet food industry.

To address the foregoing rancidity issues, in many prior animal material rendering methods and systems, citric acid, ascorbic acid, phospholipids and/or various other natural and synthetic chelating agents have been added to the materials after the pressing of the material in an attempt to stabilize the cooked material. In this regard, for the chelating agents to be effective in preventing or reducing rancidity, it has been observed that the chelating agents should be thoroughly mixed and dispersed throughout the materials. However, when attempting to achieve such mixing and dispersion in the “post-cooking” manufacturing of the meals, the mixing and dispersion has proven to be difficult. Often such cooked materials are in the form of a larger materials having limited surface area or are in the form of a dry meal or coarse powders, such that achieving the mixing and dispersion necessary to provide for molecular chelation throughout the material is unattainable. Indeed, in most rendering processes, where the chelating agents are typically sprayed onto the processed animal materials, such formulas do not migrate efficiently, and thus, do little to promote the stability and shelf-life of the materials, which is of great importance in animal material rendering processes.

### SUMMARY

The present invention relates to methods for rendering animal materials, such as poultry or fish materials, wherein a chelating solution is applied to the materials at the outset of a rendering process to provide processed animal materials that are resistant to rancidity and are stable over an extended period of time.

In an exemplary implementation of the methods for rendering animal materials of the present invention, one or more animal materials, such as poultry materials, fish materials, beef materials, pork materials, lamb materials, or combinations thereof, are initially provided and are placed in a cooker. Then, prior to heating the materials in the cooker, an amount of a chelating solution is added to the animal materials. The animal materials are then heated in the cooker to thereby release at least some water and fat from the animal materials, and are subsequently pressed to release additional water and fat from the animal materials. The pressed animal materials are then separated into discrete portions to provide an increased surface area onto which an antioxidant composition is subsequently applied, and are further dried as necessary.

In some implementations of the methods of the present invention, the chelating solution comprises citric acid, ascorbic acid, ethylenediaminetetraacetic acid (EDTA), lecithin, or combinations thereof in an amount sufficient to bind any free metal ions present in the animal materials and thereby reduce the concentration of free metal in the animal materials. In some implementations, the amount of chelating solution added to the animal materials prior to heating the materials in the cooker comprises about 5 to about 500 parts per million by weight of the animal materials. In some implementations, about 50 to about 200 parts per million of a citric acid solution is applied to the animal materials to thereby bind free metal ions and minimize the catalytic effect of non-chelated metals in the animal materials being rendered. In some implementations, an amount of metal in the animal materials is first determined, and the amount of chelating solution to be added to the animal materials is then calculated based on the determined amount of metal in the animal materials.

In certain implementations of the present invention, the manner in which the chelating solution is applied to the raw materials depends, at least in part, on the particular type of cooker that is used for the rendering process. For example, in some implementations that make use of a batch cooker, the chelating solution is poured onto the animal materials subsequent to introducing the animal materials into the batch cooker. In other implementations that make use of a continuous feed and discharge cooker, the chelating solution is sprayed onto the animal materials before or as the animal materials are being introduced in the continuous feed and discharge cooker.

Thus, the methods of the present invention allow for the rendering of animal materials using a variety of cookers and in a manner that allows a chelating solution to be dispersed throughout the materials prior to and during heating to thereby stabilize the animal materials and minimize the possibility of rancidity. The methods of the present invention also allow a minimal amount of chelating solution to be used, yet allow for the rendering of animal materials in a manner that provides an optimal result in terms of product quality, which is of great importance in economically and efficiently implementing methods of rendering animal materials.

### BRIEF DESCRIPTION OF THE DRAWING

FIG. 1 is a flow chart illustrating the steps included in an exemplary method of rendering animal materials in accordance with the present invention.

### DESCRIPTION OF EXEMPLARY EMBODIMENTS

The present invention relates to methods for rendering animal materials and, more particularly, a method for rendering animal materials that addresses the above-described problems of rancidity by applying a chelating solution to the animal materials at the outset of the rendering process.

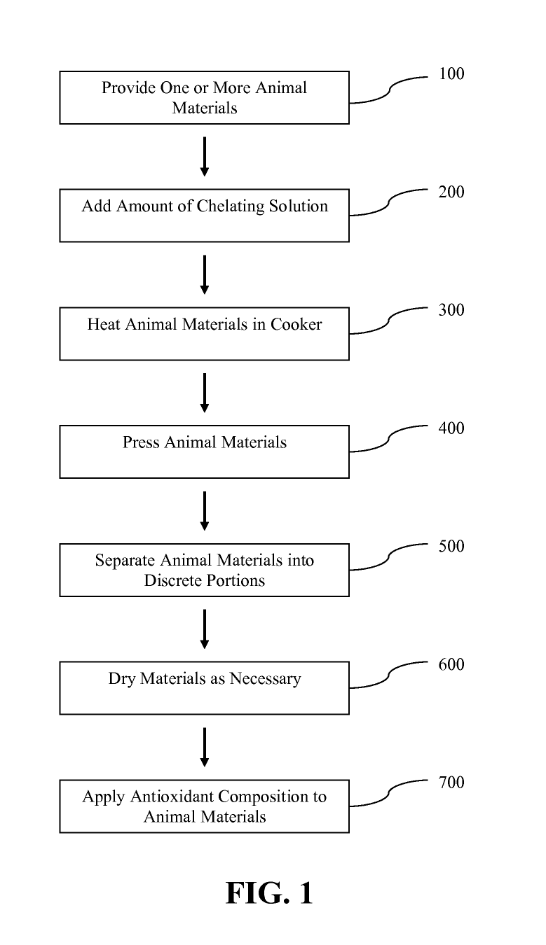

With reference to the flow chart of FIG. 1, in one exemplary implementation of a method of rendering animal materials of the present invention, one or more animal materials are first provided as indicated by block 100. As would be recognized by those skilled in the art, the term “animal materials” as used in reference to a rendering process refers to any material derived from the body of a non-human animal, including, but not limited to, the bones, tissues, organs, and bodily fluids of an animal. Typically, however, in a rendering process the animal materials utilized are those derived from the carcasses of animals, where portions of the animals intended for human consumption have previously been removed. In this regard, in some implementations of the methods of the present invention, the term “animal material” is used synonymously with the term “animal by-product.” In some implementations, the animal materials rendered by the methods of the present invention are selected from poultry materials, fish materials, beef materials, pork materials, lamb materials, and other animal materials or combinations thereof, as it has been determined that the methods of the present invention are particularly beneficial in rendering those animal materials due to the high levels of metals that are typically found in those animal materials.

Regardless of the particular animal materials utilized, once the animal materials have been provided, an amount of a chelating solution is then added to the raw animal materials at the outset of the rendering process before the animal materials are heated in the cooker, as indicated by block 200 in FIG. 1. By adding the chelating solution prior to the heating of the animal materials in the rendering process, it has been observed that the chelating agents within the solution are much more readily dispersed throughout the animal materials when the materials are in the raw condition and sufficient water or other liquid is present prior to cooking, and are thus more likely to be brought into contact with catalytic, free metal ions present in the animal materials. Moreover, it has been observed that the addition of the chelating solution prior to heating the animal materials does not lead to adverse effects for the chelating agents in subsequent processing steps, as the chelating agents have been observed to retain their ability to stabilize the animal materials, including the fat contained in the dry meal and the liquid fat, throughout the rendering process to thereby minimize the possibility of rancidity as described in further detail below.

With respect to the types of chelating solutions used in accordance with the present invention, in some implementations, the chelating solution comprises citric acid, ascorbic acid, ethylenediaminetetraacetic acid (EDTA), lecithin, or combinations thereof in a suitable solvent, such as water, fat, or other suitable organic solvents. In some implementations, the chelating solution that is utilized is citric acid. Of course, any other chelating agent that can be combined with a solvent to create a chelating solution capable of reducing a concentration of free metal ions in animal materials can also be used without departing from the spirit and scope of the present invention.

As noted above, the selected chelating solution added to the animal materials is typically added in an amount sufficient to suitably bind any metal ions, such as iron, copper, and nickel ions, in the animal materials and thereby reduce the concentration of free metal ions and minimize their catalytic effects. In some implementations of the present invention, the amount of the chelating solution added to the animal materials prior to heating the animal materials in the cooker comprises about 5 parts per million (ppm), about 10 ppm, about 15 ppm, about 20 ppm, about 25 ppm, about 50 ppm, about 75 ppm, about 100 ppm, about 125 ppm, about 150 ppm, about 175 ppm, or up to about 200 ppm by weight of the animal materials being rendered (e.g., by weight of the uncooked materials). In some implementations, about 50 to about 150 ppm, such as about 100 ppm, by weight of the animal materials being rendered is added to the animal materials. In some implementations, about 50 to about 200 ppm of a citric acid solution is applied as a chelating solution to thereby bind free metal ions and minimize the catalytic effect of the non-chelated metals in the animal materials being rendered.

In some implementations of the methods of the present invention, the amount of a particular chelating solution can vary depending on the specific chelating agent or agents being used or depending on the particular animal materials that are undergoing the rendering process. Due to the high variability of the levels of non-chelated metals in bone and certain other tissues and organs that are present in raw animal materials, such as poultry and fish by-products, and due to the complexity of determining the exact amount of non-chelated metals in each batch of raw animal materials, in some implementations, an amount (e.g., an average amount) of non-chelated metals by weight of a particular animal material can first be determined for that particular animal material, and then a predetermined amount of chelating solution sufficient to bind the metal ions in that amount of animal materials can then be added to the animal materials for all subsequent batches. In other implementations, the amount of the chelating solution necessary for a particular application can be determined, at least in part, by first analyzing or otherwise determining an amount of free metal present in each batch or amount of raw animal materials. In such implementations, the amount of chelating solution added to the animal materials can then be based on the determined amount of metal in the particular batch of animal materials.

Numerous methods known to those of ordinary skill in the art can, of course, be used to measure an amount of metal in animal materials, including, but not limited to, atomic absorption spectroscopy, inductively coupled plasma mass spectroscopy (ICP-MS), and the like. For example, in some implementations, the amount of metal in an amount of animal materials can be determined by ashing a sample from the animal materials and then measuring the amount of metal in the materials using one of the foregoing techniques.

In certain implementations of the methods of the present invention, the manner in which the chelating solution is applied to the raw materials depends, at least in part, on the particular type of cooker that is used for a specific rendering process. For example, in some implementations that make use of a batch cooker, where a desired amount or batch of animal materials is loaded into a single vessel and processed in that vessel until it is removed at the end of the cooking process, the chelating solution is poured into the batch cooker and onto the animal materials prior to heating the animal materials in the batch cooker. In other implementations that make use of a continuous feed and discharge cooker, which is comprised of a cooking vessel equipped with a mechanism, such as a conveyor belt, that continuously moves the animal material through the cooker, the chelating solution is sprayed onto the materials before or as the animal materials are being introduced into the continuous feed and discharge cooker. In this regard, in such spraying implementations, automated metering can further be utilized to ensure the proper amount of the chelating solution is added to the raw materials.

Irrespective of the manner in which the chelating solution is added to the animal materials, once the chelating solution is sprayed on or otherwise added to the raw animal materials, the materials are then heated in the cooker as indicated by block 300 in FIG. 1, and as discussed above, the water and water-based substances in the materials begin to evaporate, the proteins break down, and the fats and lipids separate from the solid materials. After the cooking process is complete, the solid materials are then pressed to squeeze and release the remaining fat and water from the material, as indicated by block 400. Following the pressing of the animal materials, the materials are then typically ground and screwed, and are separated into discrete portions, as indicated by block 500, by passing the materials through a hammer mill or similar machine to break or crush the material into a dry meal or coarse powder. In certain implementations, depending on the amount of water or other liquid remaining in the materials after cooking, the materials are further dried, as necessary, as indicated by block 600.

By breaking or crushing the materials into smaller, discrete portions, the animal materials are made to have an increased surface area onto which an antioxidant composition is then applied, as indicated by block 700, to prevent the oxidation of the processed animal materials and assist in extending the shelf-life of the processed animal materials (e.g., animal feed). In certain implementations, the antioxidant compositions can be applied to the animal materials during the cooking process or at anytime thereafter to prevent the oxidation of the materials. Without wishing to be bound by any particular theory, however, it is believed that the addition of the antioxidant compositions during the cooking of the materials can result in a loss of an amount of antioxidant composition from the cooking mixture, thus requiring the animal materials to be supplemented with additional antioxidant compositions during and/or after cooking As such, in some implementations, and as noted above, the antioxidant compositions are applied subsequent to the cooking of the materials to avoid the use of increased amounts of antioxidant compositions during the rendering process.

With regard to the antioxidant compositions used in accordance with the present invention, any number of antioxidant compositions known to those of ordinary skill in the art can be utilized, including, but not limited to, tocopherol, oil of rosemary, lecithin, and the like, as well as any other food grade synthetic antioxidant, such as butylated hydroxyanisole (BHA), butylated hydroxytoluene (BHT), tertiary butylhydroquinone (TBHQ), or propyl gallate. In some embodiments, an antioxidant composition is used that comprises, per 100 parts by weight of animal fat in the processed animal materials, about 0.01 to 2.0 parts by weight of lecithin, about 0.0035 to 0.2 part by weight of tocopherol, and about 0.02 to 0.20 parts by weight of oil of rosemary, such as that described in U.S. Pat. No. 5,498,434, which is incorporated herein by reference in its entirety. In some implementations of the present invention, the addition of the chelating solution at the outset of the rendering process allows for an increased amount of the antioxidant composition to remain available in the processed animal materials (i.e., a residual amount of the antioxidant composition) for a longer period of time, such that the residual antioxidant compositions can further assist in extending the shelf-life of the processed animal materials.

The above-described methods for rendering animal materials, in which a chelating solution is added to the animal material at the outset of the process and prior to heating the animal materials in the cooker, are important both for stabilizing the processed animal materials and minimizing the possibility of rancidity. Furthermore, the ability to utilize a minimal amount of chelating solution without sacrificing the quality of the resulting products and the antioxidant levels found within those products provides a unique way of economically and efficiently implementing a method of rendering animal materials, with the added benefit that the products produced by the present methods display a longer shelf-life.

The present invention is further illustrated by the following specific but non-limiting examples.

### EXAMPLES

Rancidity or the future stability of a fat or fat-bearing animal material can be analyzed by several methods, including headspace space extraction of the by-products of rancidity or by extracting fat from the meal and running suitable analysis for peroxide values, aldehyde presence, oxidative stability, and/or the retention of uncompromised antioxidants. Similarly, shelf-life can be determined by storing the stabilized samples for the appropriate periods of time under controlled conditions and then periodically analyzing samples for the same criteria. With these methodologies in mind, a number of experiments were undertaken to examine the effect of adding various amounts of a chelating solution to animal materials prior to heating the animal materials in a cooker. Briefly, chicken materials comprising edible chickens whose breast and thigh fillets were removed were first provided and were loaded into a batch cooker containing approximately 20% to 30% of previously-rendered chicken fat. The animal materials were then mixed within the cooker while the cooker was heated to a temperature of approximately 240° F. to 250° F., at which point most of the free water in the chicken material had been removed by evaporation. The cooked product was then conveyed to a press where the liquid fat and water were further removed from the fat-bearing meal. That meal was then conveyed to a grinder and/or hammer mill and ground to produce discrete portions of the materials. The product was then sprayed with a tocopherol-based antioxidant composition, as described in U.S. Pat. No. 5,498,434, and was evaluated at various time intervals to determine its peroxide value and to determine the residual tocopherol remaining in the materials, so as to assess, respectively, the quality or rancidity of the processed materials and the long-term stability of the materials. In this regard, samples of the resultant chicken meal were analyzed by extracting the samples at low temperatures with petroleum ether and a soxhlet extraction apparatus. The fat obtained from that extraction was then analyzed using the standard AOCS test method Cd 8-53 to assess peroxide values, while the residual tocopherol was determined by analyzing the resultant fat with high-performance liquid chromatography (HPLC; normal phase) with ultraviolet (UV) and fluorescence detection.

After completing that initial processing of the chicken materials, additional rendering methods were performed where further batches of chicken materials were processed by adding a chelating solution to the chicken materials prior to the heating of the chicken materials in the batch cooker. In the first of these additional batches, the process was performed by adding a 10% aqueous citric acid solution in a quantity sufficient to add 50 ppm of citric acid on a dry weight basis to the fresh materials (i.e., not including the liquid fat added to the cooker). Subsequent batches were then run using 100 ppm citric acid, 150 ppm citric acid, and 200 ppm citric acid so as to determine the level of citric acid that was optimal for that particular raw material and process. Tables 1 to 4 below show the peroxide values and residual tocopherol levels measured at various time intervals subsequent to processing the chicken material without and with the foregoing concentrations of citric acid.

TABLE 1
Evaluation of Peroxide Value and Residual
Tocopherol 12-hours Post Rendering.

| Citric Acid (ppm) | Peroxide Value (meq) | Residual Tocopherol (ppm) |
|---|---|---|
| 0 | 1.08 | 103 |
| 50 | 1.01 | 142 |
| 100 | .96 | 151 |
| 150 | .80 | 148 |
| 200 | 1.02 | 143 |

TABLE 2
Evaluation of Peroxide Value and Residual
Tocopherol 180-hours Post Rendering.

| Citric Acid (ppm) | Peroxide Value (meq) | Residual Tocopherol (ppm) |
|---|---|---|
| 0 | 6.17 | 11 |
| 50 | 3.42 | 86 |
| 100 | 2.71 | 103 |
| 150 | 2.68 | 101 |
| 200 | 2.47 | 98 |

TABLE 3
Evaluation of Peroxide Value and Residual
Tocopherol 348-hours Post Rendering.

| Citric Acid (ppm) | Peroxide Value (meq) | Residual Tocopherol (ppm) |
|---|---|---|
| 0 | 14.42 | 6 |
| 50 | 4.87 | 67 |
| 100 | 2.92 | 71 |
| 150 | 2.94 | 66 |
| 200 | 2.86 | 68 |

TABLE 4
Evaluation of Peroxide Value and Residual
Tocopherol 516-hours Post Rendering.

| Citric Acid (ppm) | Peroxide Value (meq) | Residual Tocopherol (ppm) |
|---|---|---|
| 0 | 45.11 | 2 |
| 50 | 7.79 | 23 |
| 100 | 3.08 | 47 |
| 150 | 3.10 | 45 |
| 200 | 3.20 | 49 |

Upon analysis of the results from the foregoing evaluations, it was observed that the addition of a citric acid chelating solution prior to the heating of the chicken materials surprisingly and significantly decreased the peroxide values of the processed materials and surprisingly and significantly increased the residual tocopherol levels in the materials at each of the time points that were measured, thus indicating that the addition of a chelating solution prior to the heating of the animal materials is useful in a method of rendering animal materials. Moreover, the foregoing results unexpectedly demonstrated that the use of greater than about 100 ppm of citric acid resulted in only minor changes to the measured peroxide values and residual tocopherol levels, indicating that the use of specific concentrations of chelating solutions over a particular level will only result in small improvements in product quality and residual antioxidant levels. As such, it was also unexpectedly found that the methods of the present invention allowed for a minimal amount of a chelating solution to be utilized while still providing an optimal result in terms of product quality and antioxidant levels.

One of ordinary skill in the art will also recognize that additional implementations are possible without departing from the teachings of the present invention. This detailed description, and particularly the specific details of the exemplary implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for rendering animal materials, comprising the steps of:
providing one or more animal materials;
adding an amount of a chelating solution to the animal materials prior to heating the animal materials in a cooker;
heating the animal materials in the cooker to thereby release at least some water and fat from the animal materials;
pressing the animal materials to further release water and fat from the animal materials; and
applying an antioxidant composition to the animal materials.

2. The method of claim 1, wherein the animal materials are selected from poultry materials, fish materials, beef materials, pork materials, lamb materials, and combinations thereof.

3. The method of claim 1, wherein the chelating solution comprises citric acid, ethylenediaminetetraacetic acid (EDTA), ascorbic acid, lecithin, or combinations thereof.

4. The method of claim 3, wherein the chelating solution comprises citric acid.

5. The method of claim 1, wherein the amount of the chelating solution comprises about 5 to about 500 parts per million by weight of the animal materials.

6. The method of claim 5, wherein the amount of the chelating solution comprises about 100 parts per million by weight of the animal materials.

7. The method of claim 1, further comprising the step of determining an amount of a metal in the animal materials prior to adding the chelating solution.

8. The method of claim 7, wherein the step of adding the amount of the chelating solution to the animal materials comprises adding the amount of the chelating solution based on the determined amount of metal in the animal materials.

9. The method of claim 1, wherein the cooker is a batch cooker.

10. The method of claim 9, wherein the step of adding the chelating solution to the animal materials comprises pouring the chelating solution onto the animal materials subsequent to introducing the animal materials into the batch cooker.

11. The method of claim 1, wherein the cooker is a continuous feed and discharge cooker.

12. The method of claim 11, wherein the step of adding the chelating solution to the animal materials comprises spraying the chelating solution onto the animal materials as the animal materials are introduced into the continuous feed and discharge cooker.

13. The method of claim 1, wherein the step of applying the antioxidant composition comprises spraying the antioxidant composition onto the animal materials.

14. The method of claim 13, further comprising the step of separating the animal materials into discrete portions prior to spraying the antioxidant composition onto the animal materials.

15. A method for rendering animal materials, comprising the steps of:
providing one or more animal materials;
adding an amount of a citric acid solution to the animal materials prior to heating the materials in a batch cooker, the amount of the citric acid solution comprising about 50 to about 200 parts per million by weight of the animal materials;
heating the animal materials in the batch cooker to thereby release at least some water and fat from the animal materials;
pressing the animal materials to further release water and fat from the animal materials; and
applying an antioxidant composition to the animal materials.

16. The method of claim 15, wherein the animal materials are selected from poultry materials, fish materials, beef materials, pork materials, lamb materials, and combinations thereof.

17. The method of claim 15, wherein the step of applying the antioxidant composition comprises pouring the antioxidant composition onto the animal materials.

18. The method of claim 15, further comprising the step of separating the animal materials into discrete portions prior to applying the antioxidant composition onto the animal materials.

19. A method for rendering animal materials, comprising the steps of:
providing one or more animal materials;
adding an amount of a citric acid solution to the animal materials prior to heating the materials in a batch cooker, the amount of the citric acid solution comprising about 50 to about 200 parts per million by weight of the animal materials;
heating the animal materials in the batch cooker to thereby release at least some water and fat from the animal materials;
pressing the animal materials to further release water and fat from the animal materials;
separating the animal materials into discrete portions; and
applying an antioxidant composition to the animal materials.

20. The method of claim 19, wherein the animal materials are selected from poultry materials, fish materials, beef materials, pork materials, lamb materials, and combinations thereof.
